(19) United States
(12) Patent Application Publication
(10) Pub. No.: US 2005/0184562 A1
(43) Pub. Date: Aug. 25, 2005

(54) Method and apparatus for controlling movement of a cover of an openable vehicle roof

(75) Inventors: Jan Truol, Griesheim (DE); Detlef Heyn, Kirchhain (DE)

Correspondence Address: CARLSON, GASKEY & OLDS, P.C., 400 WEST MAPLE ROAD, SUITE 350, BIRMINGHAM, MI, 48009, US

(73) Assignee: ArvinMeritor GmbH

(21) Appl. No.: 11/053,293

(22) Filed: Feb. 8, 2005

(30) Foreign Application Priority Data
Feb. 19, 2004 (DE) 10 2004 008 174.3

(51) Int. Cl. B60J 7/057

(52) U.S. Cl. 296/223

(57) ABSTRACT

A method and apparatus for controlling movement of a cover of an openable vehicle roof utilizes a control device and a plurality of sensors. A presence of a roof structure, such as a roof rack, is detected by the plurality of sensors. Once the presence of a roof rack is detected, raising movement of the cover or traveling movement of the cover across a stationary rear roof region is prevented.

### RELATED APPLICATIONS

The application claims priority to German Application Serial No. 10 2004 008 174.3, which was filed on Feb. 19, 2004.

### BACKGROUND OF THE INVENTION

The invention relates to a method and apparatus for controlling the movement of a cover in a vehicle roof that selectively closes or exposes a roof opening, and includes a control device for the cover that is particularly useful for a sliding roof.

In the following, the term “sliding roof” may be understood as representing a conventional sliding/raising roof, a segmental arch roof with separate cover elements that can be shifted individually, as well as a so-called “spoiler” roof. With a conventional sliding/raising roof, a rear edge of the cover can be raised above a roof outer skin to provide a ventilation slot. Further, on exposing the roof opening, the cover can be shifted to lie under the roof outer skin. However, the cover in a spoiler roof is shifted during retraction over a stationary rear roof portion, i.e., the spoiler roof is shifted to lie on top of the roof outer skin.

The invention particularly aims at such a spoiler roof and provides more effective control during actuation of the cover. The control for lifting or raising movement of sliding/raising roofs, however, can also be improved by using the subject invention.

### SUMMARY OF THE INVENTION

The method according to the invention provides the following steps for controlling movement of a cover for a vehicle roof. A presence of a roof structure, such as a dismountable roof build-up structure or roof rack, for example, is recognized by at least one sensor. In response to detection of the presence of the roof structure and on actuation of a switch for raising the cover, a control device coupled with the at least one sensor prevents a supply of energy to a drive responsible for movement of the cover. The control can prevent traveling movement of the cover over a stationary rear roof region and raising movement of the cover as needed.

During raising movement of the cover, such as raising of a rear edge only, or when the cover is shifted in its entirety over the stationary rear roof region, a collision with the dismountable roof build-up structure, roof rack or roof load may occur. Also during winter when roof racks are primarily used, the vehicle roof may be opened for a short time because of the increasingly sophisticated vehicular air conditioning. In either situation, damage to the cover is possible during the raising process. The method according to the invention automatically prevents the raising of the cover, if a collision with the dismountable roof build-up structure, the roof rack or the roof load is possible.

The control device for the cover has at least one sensor arranged on the vehicle roof for detecting the dismountable roof build-up structure or roof rack. The control device also includes a control unit coupled with the at least one sensor, a drive for the cover, and a switch for initiating the raising movement of the cover. The control unit is designed such that, on actuation of the switch for raising the cover, in combination with detection of the presence of a roof structure, the control unit prevents a supply of energy to the drive to prevent the raising movement and/or the traveling movement of the cover over the stationary rear roof region.

The method and the control device according to the invention can further be designed to allow the vehicle roof to be opened, for instance by displacing the cover in combination with a lowering of a rear cover edge, but not the raising of the cover.

Using microswitches for the sensors is particularly advantageous because of their ruggedness. Other variants for the design of the sensors are contact or contact-free sensors.

It is preferred that at least one or more of the sensors are integrated in a so-called “roof module,” i.e., in a composite component that is manufactured separately from a vehicle frame, and which is fixed to the latter, in particular, by gluing.

These and other features of the present invention can be best understood from the following specification and drawings, the following of which is a brief description.

### BRIEF DESCRIPTION OF THE DRAWINGS

FIG. 1 shows a perspective view of a vehicle roof with a roof module, a cover of which is connected with a control device according to the invention.

FIG. 2 shows a longitudinal section taken through the vehicle roof of FIG. 1.

FIG. 3 shows a section taken through the vehicle roof along line III-III in FIG. 1.

FIG. 4 shows an enlarged view of the area of FIG. 3 referenced by X.

FIG. 5 shows a further enlarged detail view of the area in FIG. 4 referenced by Y.

### DETAILED DESCRIPTION OF THE PREFERRED EMBODIMENT

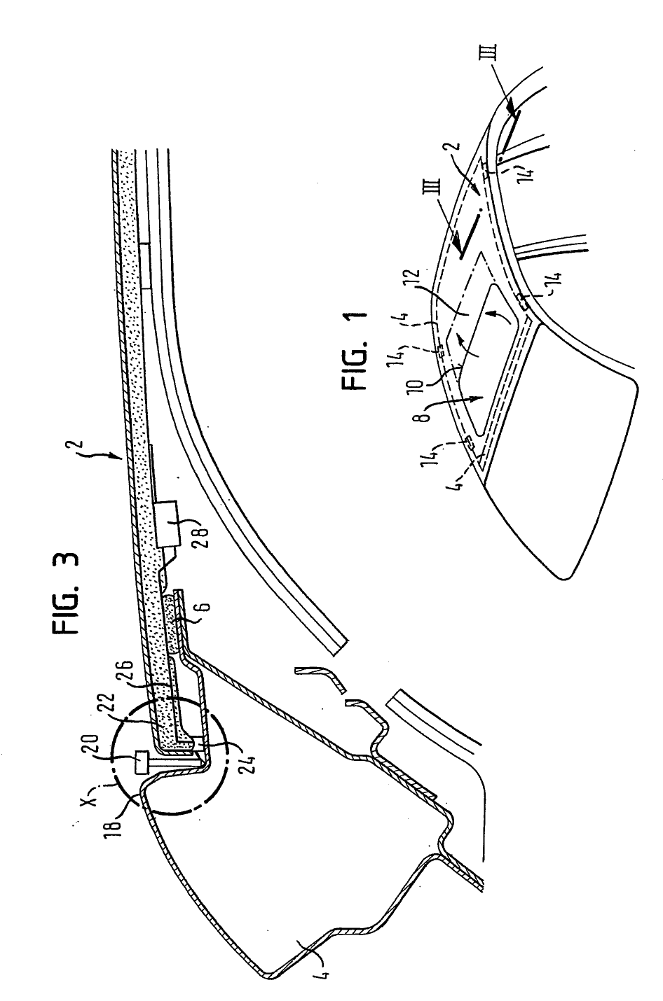

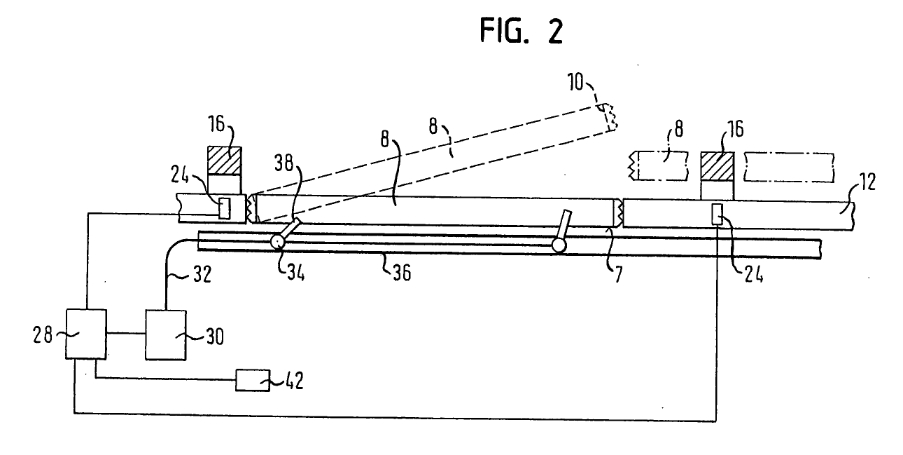

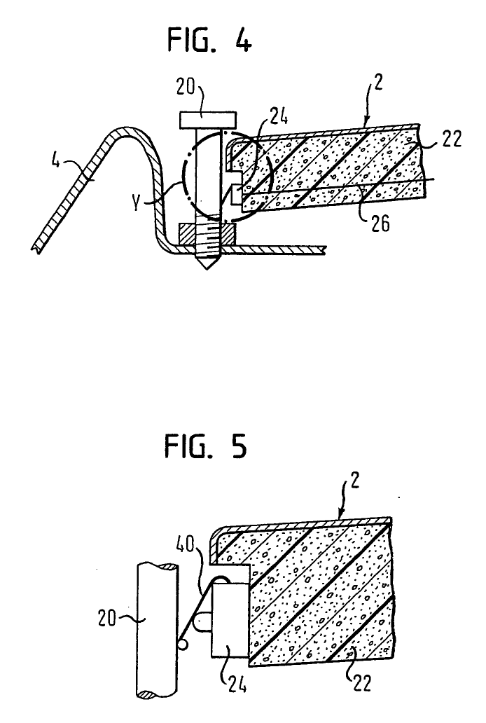

FIG. 1 shows a vehicle roof which carries a roof module 2 configured as a ready-made vendor part. The roof module 2 virtually forms a complete outer sheet or skin of the assembled vehicle roof and is fixed to a vehicle roof frame 4 by gluing. A corresponding adhesive bead 6 is provided as shown in FIG. 3. The vehicle roof can be opened, and a roof opening 7 (see FIG. 2) can be exposed by moving a rear edge 10 of a raisable and shiftable cover 8 in an upward direction. A switch 42 is actuated to move the cover 8.

If the roof opening 7 is to be exposed still further, the cover 8 can be shifted over a stationary region 12 (i.e. rear region) of the vehicle roof, namely that region adjoining the cover 8 in the direction of travel. A vehicle roof of this type is called a spoiler roof.

The cover 8 in a sliding/lifting or raising roof can alternatively be raised in the region of a roof rear edge. During shifting of the cover 8 to the rear, the cover 8 in the sliding/lifting roof configuration, however, will be moved underneath the stationary region 12 of the vehicle roof.

The vehicle roof frame 4 has four (4) predetermined fastening points 14 for attaching a roof structure, such as a dismountable roof build-up structure or roof rack 16. These fastening points 14 extend between an edge of the roof module 2 (see FIG. 3) and an upwardly projecting portion 18 of the roof frame 4. A fastening element 20 for attaching the roof build-up structure or roof rack 16 projects between the edge and upwardly projecting portion 18, and penetrates into the roof frame 4, for example. The fastening points 14, however, can also be fully integrated in the roof module 2.

In an edge portion of the roof module 2, in a region of a foam backing 22, and adjoining each fastening point 14, is mounted at least one sensor. In other words, there is at least one sensor located near each corner area, adjacent the respective fastening point 14. These sensors are preferably microswitches 24 that are connected in parallel to each other. All four (4) microswitches 24 are coupled with a control unit 28 via wires 26, which are embedded in the foam backing 22 (FIG. 3).

The control unit 28 is coupled to the switch 42 and is also connected to a drive 30 in the form of an electric motor for the cover 8 (FIG. 3). For this, a cable 32, which is guided so as to be resistant to bending, is coupled with the drive 30. The cable 32 is connected with gliders 34 shiftable in a longitudinal guide 36. The gliders 34 in turn are coupled with the cover 8 through lifting links 38, which are represented here in a very simplified manner.

As can be seen in FIG. 5, a laterally protruding switching arm 40 of the microswitch 24 is actuated as soon as the fastening element 20 is positioned on the roof frame 4.

FIG. 2 shows that during the raising of the cover 8, i.e., the moving of the rear edge 10 in an upward direction, a collision with objects that are present on the roof build-up structure or roof rack 16 may occur. The potential for collision exists because the roof build-up structure or roof rack 16 extends along the outer sheet of the roof module 2 at a relatively small distance away from the outer sheet. Retracting the cover 8 across the stationary region 12, as is illustrated with broken lines, would likewise not be possible with the roof build-up structure or roof rack 16 attached.

In order to prevent this, there is provided a control device constituted by the microswitches 24, the control unit 28 and the drive 30.

Thus, as soon as at least one fastening element 20, associated with the roof build-up structure or roof rack 16 is detected, the control unit 28 prevents a raising of the cover 8 even if the switch 42 is actuated to activate the drive 30 and raise the cover 8. The control unit 28 accomplishes this by preventing a corresponding supply of energy to the drive 30.

Although a preferred embodiment of this invention has been disclosed, a worker of ordinary skill in this art would recognize that certain modifications would come within the scope of this invention. For that reason, the following claims should be studied to determine the true scope and content of this invention.

1. A method of controlling movement of a cover of a vehicle roof, the cover selectively closing and exposing a roof opening, comprising the following steps:
a) detecting a presence of a roof structure with at least one sensor, and
b) preventing a supply of energy to a drive responsible for movement of the cover in response to actuation of a switch for raising the cover and upon detection of the presence of a roof structure.

2. The method according to claim 1, including providing a plurality of sensors on the vehicle roof for detecting the roof structure.

3. The method according to claim 2, including arranging the plurality of sensors in a region of predetermined vehicular fastening points of the roof structure.

4. The method according to claim 1, wherein the at least one sensor is a microswitch.

5. The method according to claim 1, wherein the roof structure is at least one of a dismountable roof build-up structure and a roof rack.

6. The method according to claim 1, wherein step (b) further includes preventing at least one of traveling movement of the cover across a stationary rear roof region and raising movement of the cover.

7. The method according to claim 6 wherein step (b) further includes coupling a control to the at least one sensor to control traveling movement of the cover.

8. A control device for a shiftable cover of a vehicle roof that selectively closes and exposes a roof opening, comprising:
at least one sensor for detecting a roof structure supported by the vehicle roof;
a control unit coupled with the at least one sensor;
a drive cooperating with the control unit to move the shiftable cover; and
a switch for initiating movement of the shiftable cover, wherein the control unit prevents a supply of energy to the drive in response to actuation of the switch for initiating the movement of the shiftable cover and in response to detection of the presence of a roof structure.

9. The control device according to claim 8, wherein the at least one sensor is a microswitch.

10. The control device according to claim 8, wherein the at least one sensor comprises a plurality of sensors provided on the vehicle roof for detecting the roof structure.

11. The control device according to claim 8, wherein the at least one sensor is arranged in a region of vehicular fastening points of the roof structure.

12. The control device according to claim 8, wherein the at least one sensor is integrated in a roof module.

13. The control device according to claim 8, wherein the roof structure comprises at least one of a dismountable roof build-up structure and a roof rack.

14. The control device according to claim 8, wherein the control unit prevents at least one of traveling movement of the shiftable cover over a stationary rear roof region and raising movement of the shiftable cover by preventing the supply of energy to the drive in response to actuation of the switch and detection of a roof structure.
